(19) United States
(12) Patent Application Publication
(10) Pub. No.: US 2026/0338491 A1
(43) Pub. Date: Oct. 29, 2026

(54) MODULAR HEAT EXCHANGER AND VENTILATION UNIT

(71) Applicant: LUNOS LÜFTUNGSTECHNIK GMBH & CO. KG FÜR RAUMLUFTSYSTEME, Berlin (DE)

(72) Inventor: Michael MERSCHER, Falkensee (DE)

(21) Appl. No.: 19/110,216

(22) PCT Filed: Sep. 14, 2023
(86) PCT No.: PCT/EP2023/075312

§ 371 Date: Mar. 10, 2025

(30) Foreign Application Priority Data
Sep. 14, 2022 (DE) 102022123427.4
Apr. 25, 2023 (DE) 102023110555.8

(51) Int. Cl. F28D 17/02; F24F 12/00; F28D 21/00

(52) U.S. Cl. CPC F28D 17/02; F24F 12/001; F28D 21/0014

(57) ABSTRACT

The invention relates to a heat exchanger (1) for a double-flow ventilation device comprising at least a first channel (2) configured to be traversed by an outgoing air flow (F out) and at least a second channel (3). configured to be traversed by a flow of incoming air (F in), the first channel (2) comprising at least one heat exchange surface (6) common with the second channel (3), the first channel (2) and the second channel (3) each extending longitudinally with respect to a longitudinal axis (BB) of the heat exchanger (1), characterized in that the heat exchanger (1) comprises at least a first transverse portion (1a, 1b, 1c, 1d, 1e) thermally conductive comprising a first portion of the first channel (2) and a first portion of the second channel (3), a second transverse portion (1a, 1b, 1c, 1d, 1e) thermally conductive comprising a second part of the first canal (2) and a second part of the second canal 1 (3), the first transverse portion (1a, 1b, 1c, 1d, 1e) being connected at least partially to the second transverse portion (1a, 1b, 1c, 1d, 1e) by a thermal insulation member (5).

The invention relates to a modular heat exchanger and to a ventilation system comprising such a modular heat exchanger.

Renovated and new residential buildings must be virtually airtight according to the current law. Ventilation through gaps, which used to be customary, is therefore increasingly being replaced by active ventilation concepts. This involves using house ventilation systems, the function of which is to supply outside air as required and to transport waste air to the outside.

Such ventilation systems are based on flow through the entire living space as required. In order to minimize the space required, decentralized systems comprising heat exchangers have been developed, as described, for example, in DE 10 2011 080 358 and in DE 10 014 200 538. Heat exchangers used here are preferably one-piece ceramic heat exchangers. The production of such ceramic heat exchangers is costly and energy-intensive; in addition, ceramic heat exchangers, once manufactured, can be adjusted to the situations in which they are installed only with difficulty with regard to their length.

In a first aspect, the invention relates to a modular heat exchanger as claimed in claim 1. The modular heat exchanger comprises at least two heat exchanger units in the form of gas-solid heat exchangers, each having a multitude of flow channels, and at least one connecting element by which the heat exchanger units are connectable to one another.

The invention includes the finding that, by virtue of the use of multiple heat exchanger units that are connectable to one another via a connecting element and hence collectively form the heat exchanger, it is possible to improve both the flexibility of the heat exchanger, since its construction now depends on the number and characteristics of the heat exchanger units, and energy and cost efficiency via the production of a multitude of heat exchanger units that are smaller than known heat exchangers.

In an assembled state, the heat exchanger units are connected to one another via the connecting element.

The modular construction of the heat exchanger permits uncomplicated adjustment, for example, of the length of the assembled heat exchanger to installation situations in that further heat exchanger units are added or a smaller number of heat exchanger units are connected to one another and installed, and hence the length of the heat exchanger can be adjusted.

In addition, the invention includes the finding that the modular construction permits provision of further elements between the heat exchanger units, by means of which it is possible to increase the overall efficiency of the modular heat exchanger in operation.

Furthermore, the invention includes the finding that a modular construction of the heat exchanger permits combination of different heat exchanger units and in that way, for example through skillful air guiding, use of different materials or adjustment of geometry, an increase in the efficiency of the heat exchanger as a whole.

The increases in efficiency that are achievable with the modular heat exchanger also enable the use of materials having lower heat storage capacity than ceramics, for example polymer materials, as material for the heat exchanger units, which leads to significant energy savings in manufacture and can also reduce costs further on the material side and via the usable manufacturing processes.

There follows a description of working examples of the modular heat exchanger of the invention.

Each heat exchanger unit is preferably constructed such that it extends further in at least one of its directions of extension than in the direction of extension through which the flow passes in the assembled state, i.e. than its length. In other words, each heat exchanger unit is broader or higher or has a greater diameter than its length.

Advantageously, the at least two heat exchanger units are in plate form, i.e. each have a length smaller than their diameter. By means of such comparatively short heat exchanger units, it is possible to vary the length of the assembled modular heat exchanger. Preferred lengths of the heat exchanger units are in the range from 0.5 mm to 60 mm. A preferred length is 30 mm. The heat exchanger units may preferably take the form either of plates, especially having a length of 1-2 mm, or in other words having a thickness of 1-2 mm, or of thicker plates, especially having lengths of 20-40 mm. The at least two heat exchanger units, in embodiments, have a round or polygonal cross section.

The heat exchanger units may also take the form of circle segments. These may then be assembled to form a heat exchanger having a round cross section. Alternatively, it is also possible to assemble multiple heat exchanger units having a polygonal cross section to form an exchanger having a larger polygonal cross section. In a further variant, a heat exchanger unit may also have a central cutout in which a further heat exchanger unit is disposed. In particular, one heat exchanger unit may be in annular form, and another in circular form, in which case the annular heat exchanger unit may be designed to accommodate the circular heat exchanger unit in its hollow interior.

In one embodiment, at least two heat exchanger units are in a parallel flow arrangement and hence form one plane of the modular heat exchanger. It is thus possible to use different heat exchanger units for different regions in parallel. It is further advantageous when at least one heat exchanger unit is connected in series with at least one further heat exchanger unit in an assembled state. In other words, such a plane of the heat exchanger may be assembled together with one or more heat exchanger units that form(s) a further plane to give the heat exchanger. It is thus possible to adjust the flow length of the heat exchanger.

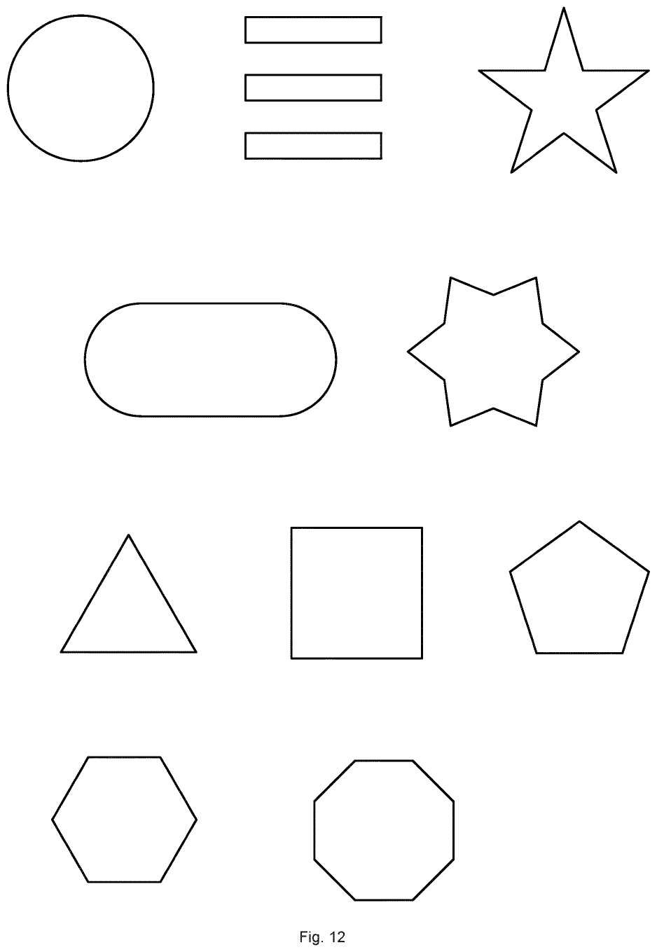

In one embodiment, in at least one of the heat exchanger units, at least one of the channels has a rectangular, hexagonal, polygonal, oval or round cross section. Examples of these can especially be found in FIG. 12 below. Preferably, at least one of the channels has a variable cross section over a length of the heat exchanger unit. In addition, at least one of the channels may be in straight or sinuous form. In particular, a sinuous design permits an increase in the effective flow length through the channel and through the windings, preferably in the form of kinks or spirals, increased contact of air molecules with the walls of the channel, which leads to improved heat transfer.

It is preferable that there is an arrangement of channels having different cross sections in at least one of the heat exchanger units, especially with cross sections that differ with regard to a basic shape and/or size. By means of variations in the channel cross sections in the heat exchanger unit, it is possible to positively influence the efficiency of the heat exchanger overall. For instance, the channel cross sections may be matched to flow profiles in the respective use of the modular heat exchanger, in order to optimize heat transfer between air conducted through the heat exchanger unit and heat exchanger unit.

It is particularly advantageous here when at least one heat exchanger unit has a channel structure that varies in a regular manner over its cross section, especially channels having greater diameter in an inner region and channels having a smaller diameter in the outer region. This means that larger areas of channel walls are available for heat transfer in the outer region which generally has greater flow when axial ventilators, for example, are used than in the inner region that has lower flow.

In one embodiment, it is further preferable when channels having a hexagonal cross section are disposed in an inner region and channels having a rectangular cross section in an outer region. Here too, the wall area for heat transfer is matched to the flow.

In a further embodiment, it is possible for individual channels to be filled in at least one of the heat exchanger units. This is advisable, for example, in channels which adjoin dead zones of a ventilator used with the modular heat exchanger and which therefore have poor or zero flow in any case. Any low flows in other channels are deflected by means of the filling of the channels, which increases the possibility of heat transferred to or from the channel walls and hence can lead to an improvement in efficiency. Furthermore, heat exchanger units through which the flow passes in series may also preferably be arranged such that closed channels of this kind are in an offset arrangement in the one heat exchanger unit with respect to closed channels in the other heat exchanger unit, and hence there is a further improvement in heat transfer via multiple deflection of the air flow.

In a further embodiment, the heat exchanger comprises at least one blockade body which is in the form of circle segments and does not have any flow channels and which is connectable via the at least one connecting element to at least one of the heat exchanger units.

With the aid of the blockade body, it is possible to achieve even greater air rotation in the heat exchanger because no flow is possible through the region of the blockade body. Especially in embodiments in which multiple blockade bodies in series are in an offset arrangement to one another in flow direction, these also prevent a subjective impression of a hole in the wall when looking through the heat exchanger.

The blockade body preferably comprises a ceramic, a polymer material, especially polystyrene or ABS, or a metallic material, especially a stainless steel.

In one embodiment, at least one of the heat exchanger units comprises a ceramic, a polymer material, especially polystyrene or ABS (acrylonitrile-butadiene-styrene copolymer), or a metallic material, especially a stainless steel or aluminum. The modular construction of the heat exchanger and the associated mechanical options for optimization of heat transfer between air flow and heat exchanger unit enables not only standard materials for heat exchangers such as ceramic or metals but also utilization of polymer materials in the heat exchanger unit, which enable much cheaper manufacturing processes.

The connecting element may be manufactured from the same material as the heat exchanger unit, but it is also possible to use different materials for connecting element and heat exchanger unit; for example, the heat exchanger unit may be formed from ceramic and the connecting element from a polymer material.

In one embodiment, at least one of the channels of at least one of the heat exchanger units has an internal coating or internal structuring. More preferably, the internal coating is sand or a comparable grainy material, which is especially applied by adhesive bonding, and/or a metallic, ceramic or polymer coating, and especially comprises a different material than the heat exchanger unit. By means of such coating, it is possible to further improve the efficiency of the modular heat exchanger in that the internal surface area of the respective channel available for heat transfer is increased, or by the use of materials having higher thermal conductivity in the coating.

At least one of the heat exchanger units and/or the at least one connecting element are preferably injection-molded, extruded or manufactured by 3D printing. Other suitable manufacturing methods are machining, rolling or winding.

In one embodiment, the connecting element is formed on at least one of the heat exchangers.

Alternatively, the connecting element may also be a separate component, especially a connecting element disposed between the heat exchanger units or an acceptor disposed around at least parts of the heat exchanger units or a housing around the heat exchanger units. In a further embodiment, especially in the case of very thin heat exchanger units, the connecting element may also be a rod, especially a threaded rod, on which the heat exchanger units are preferably in a spaced-apart arrangement. The spacing may be ensured by spacers between the heat exchanger units or by positioning elements mounted on the connecting element, for example nuts in the case of threaded rods or stops. It is also possible for the heat exchanger units to be connected to the connecting element via an adhesive bond, welding or other cohesive bond, and for the spacings to be ensured in this way.

The at least one connecting element, in one embodiment, has at least two springs for engagement in one groove each on one of the heat exchanger units. It is also possible for multiple grooves to be present in the heat exchanger unit, in order to be able to vary the position of the heat exchanger unit. It is also possible for breaks to be used on the connecting element. It is also possible for a thread or a threaded part to be introduced on the connecting element, into which the heat exchanger units can be screwed.

It is preferable that the at least one connecting element has a hermetic seal to the outside and in particular has sealing structures such as sealing lips. This means that unwanted flow loss to the outside can be avoided, and airtightness requirements for ventilation systems can be satisfied.

The connecting element may additionally have thermal insulation. In particular, it is also possible for thermal insulation to be arranged around the whole modular heat exchanger for avoidance of unwanted heat losses.

It is particularly preferable when, in an assembled state, an inflow plane of one heat exchanger unit is spaced apart from an outlet plane of the other heat exchanger unit by 1-10 mm, preferably in the range of 3-5 mm. Such a separation of the heat exchanger units from one another leads to vortexing of the air flow in the resultant interspace and hence to a more homogenized distribution of the air flow over the cross section of the heat exchanger unit on entry into the heat exchanger unit than is the case when the heat exchanger units directly adjoin one another. This means that more uniform flow in turn further improves the efficiency of the modular heat exchanger. The inflow and outflow planes in this connection means the entrance and exit planes of the flow channels of the heat exchanger unit. These planes, depending on the design of the heat exchanger unit, may also be of convex or concave shape. Inflow and outflow plane relate to a particular flow direction in which flow passes successively through the heat exchanger units. Since flow is possible in two directions through the modular heat exchangers of the invention, the inflow and outflow planes cannot be distinguished by construction features, but relate to a particular flow direction. Thus, when the flow direction is changed, an inflow plane becomes an outflow plane, and vice versa.

The modular heat exchanger as claimed in any of the preceding claims preferably comprises a spacer disposed between the at least two heat exchanger units in an assembled state, where the spacer is formed on at least one of the heat exchanger units or as a separate spacer or as part of the connecting element. By means of such a spacer, it is possible to maintain compliance with a predetermined spacing. Possible embodiments include, for example, stops for the heat exchanger units on the connecting element, or edges or elements that protrude beyond the inflow or outflow plane of at least one of the heat exchanger units. These elements may, for example, be wall elevations of the walls of particular channels.

In preferred embodiments, the spacer may be designed and/or arranged so as to fluidically separate a first set of channels of a heat exchanger unit from a second set of channels of that heat exchanger unit in the assembled state. It is thus possible to direct air flows in a fluidically separated manner, but also to decouple subregions of the heat exchanger unit from the air flow and to guide electric wires, for example, in the channels of the subregions or not to use these channels in some embodiments.

In one embodiment, at least one of the heat exchanger units is in a curved shape, especially a concave shape, on at least one side. By means of a concave shape of the heat exchanger unit, a distance between two heat exchanger units in an inner region is greater than in the outer region. In that way, it is likewise possible to achieve an advantageous spacing as elucidated above, in which the flow is vortexed and hence more uniform flow is possible toward the heat exchanger unit over its cross section.

In one embodiment, the at least one connecting element and/or the spacer has a dividing wall, by means of which two air streams are fully fluidically separable from one another, where the dividing wall is in particular a straight wall or a closed ring. This embodiment permits the use of the modular heat exchanger even in applications in which two air flows are guided in fluidic separation from one another within a housing. Such a dividing wall may also be provided as a separate element, for example provided with seals, in the modular heat exchanger or be implemented as an integral part of one or more of the heat exchanger units. Such a dividing wall may also separate two regions of the heat exchanger unit from one another, of which only one is flowed through in operation, while the other can be utilized for passage of cables or the like.

In one embodiment, there is a porous material disposed between the at least two heat exchanger units in an assembled state, where the porous material is especially a wadding, a fleece, a foam material. It is particularly advantageous here when the porous material has a cell structure which is thin compared to passages in the porous material. Foam materials used are preferably foam materials having an amount of pores in the range of 10-30 ppi, further preferably of 10-20 ppi. The porous material between the heat exchanger units ensures further deflections or breaking of the air flow, which in turn contributes to an increase in heat transfer in the continuous channels downstream and hence an improvement in efficiency.

In preferred embodiments, the at least two heat exchanger units are of different construction; in particular, they have different lengths, different channel structures and/or different materials. These embodiments can further increase the efficiency of the modular heat exchanger since the heat exchanger units can be matched individually to the flow characteristics in the particular case. The channel structures preferably differ here in diameter, wall thickness and/or cross-sectional shape of the channels. It is also possible in each case for different regions to be completely closed.

Alternatively, it is also possible for several or all heat exchanger units in a heat exchanger to have the same construction. This permits reduction of manufacturing costs.

In a further embodiment, the at least two heat exchanger units are in a mutually twisted arrangement in an assembled state. In this way, it is ensured that it is at least not possible at all points in the cross section of the heat exchanger units for the flow to go directly from a channel in one heat exchanger unit into a channel in the next heat exchanger unit; this leads to deflection of the flow and increases the chance that air molecules will come into contact with the channel walls in the channel of the next heat exchanger unit. Heat transfer is thus promoted, and the efficiency of the modular heat exchanger increased. Two successive heat exchanger units are preferably mutually twisted at an angle of 30° or 60°.

Alternatively, the at least two heat exchanger units may also be in a flush arrangement, such that an air flow can flow unhindered through the channels in each case. It is thus possible for a higher volume flow rate or a lower pressure buildup to be achieved than is the case for mutually twisted heat exchanger units and hence offset flow pathways.

In one embodiment, the modular heat exchanger comprises at least three heat exchanger units, where a first and a second heat exchanger unit have a different rotation angle to one another than the second heat exchanger unit and a third heat exchanger unit. In this way, the deflection of the flow is forced at least in some channels and hence efficiency is increased further.

In a second aspect, the invention relates to a ventilation system having at least one ventilator which is in particular bidirectionally operable and at least one modular heat exchanger according to the first aspect of the invention. The use of the modular heat exchanger can especially increase the efficiency of the ventilation system as a whole; in this way, more heat can be stored in one cycle and released in the next.

In one embodiment of the ventilation system, a flow homogenizer made of porous material is disposed between the bidirectionally operable ventilator and the modular heat exchanger, and the deflectors thereof deflect air molecules so as to compensate for dead zones that arise behind the ventilator.

In a third aspect, the invention relates to a twin ventilation system for interior ventilation, having, in a common housing,
a first air guiding device for guiding a first air stream, having a first outlet on the interior side, a first flow space in which at least one first bidirectionally operable ventilator is disposed, and a first outlet on the outside,
a second air guiding device for guiding a second air stream, entirely fluidically separated from the first air guiding device and having a second outlet on the interior side, a second flow space in which at least one second bidirectionally operable ventilator is disposed, and a second outlet on the outside,
a modular heat exchanger according to the first aspect of the invention which extends within the first and second air guiding devices, is disposed between the respective outlets on the interior side and the outside in both air guiding devices, and is designed to guide the first air stream and the second air stream in a fluidically separated but thermally coupled manner, where the modular heat exchanger additionally forms a regenerator in each case in the first and second air guiding devices,
wherein the first and second outlets on the interior side are in a fluidically completely separated arrangement in a common part-housing on the interior side, and the first and second outlets on the outside are in a fluidically completely separated arrangement in a common part-housing on the outside, and
wherein the first and second flow spaces and the modular heat exchanger are disposed in a common middle portion of the housing.

In particular, suitable embodiments for this purpose are those in which there is a dividing wall for fluidic separation of the first and second air streams in the modular heat exchanger. But alternative implementations of the air flow separation such as sealing elements are also possible.

Possible executions and advantages described with regard to the modular heat exchanger in the first aspect of the invention likewise relate to the ventilation system according to the second aspect of the invention and the twin ventilation system. For instance, any embodiments and developments of the modular heat exchanger may be used for the (twin) ventilation system, as elucidated with regard to the first aspect of the invention. For further advantages, execution variants and execution details of these further aspects and their possible developments, reference is therefore also made to the preceding description relating to the corresponding features and developments of the modular heat exchanger.

Preferred embodiments of the invention are elucidated by way of example with reference to the appended figures. The figures show.

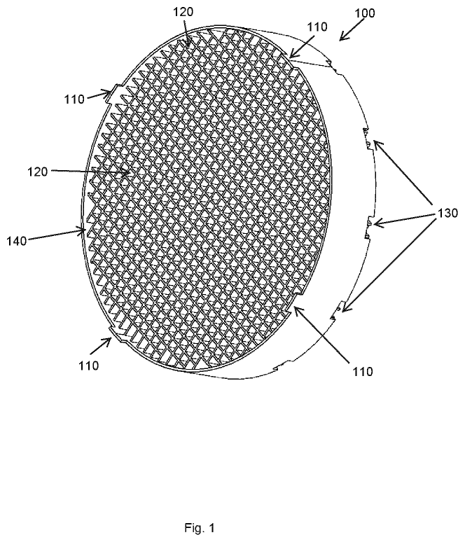

FIG. 1: a three-dimensional diagram of a heat exchanger unit of one embodiment of a modular heat exchanger of the invention,

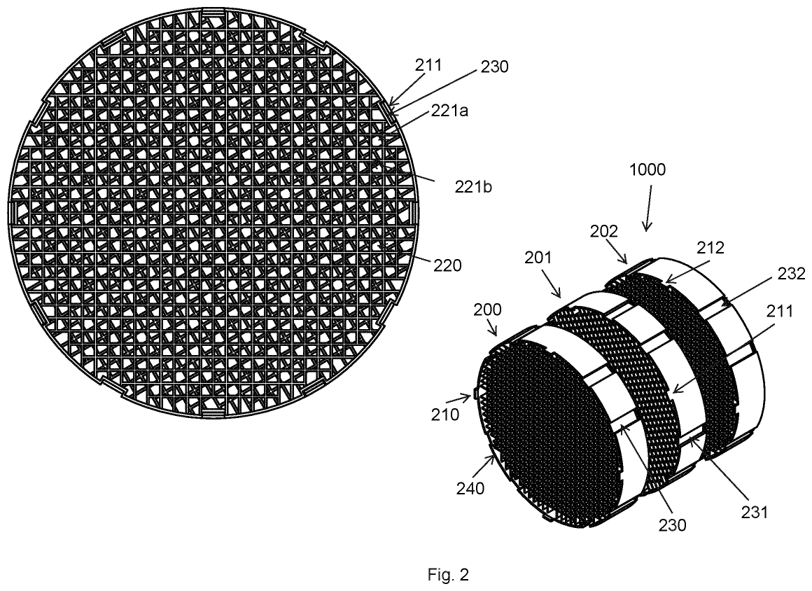

FIG. 2: a front view and an exploded diagram of one embodiment of a modular heat exchanger having three heat exchanger units,

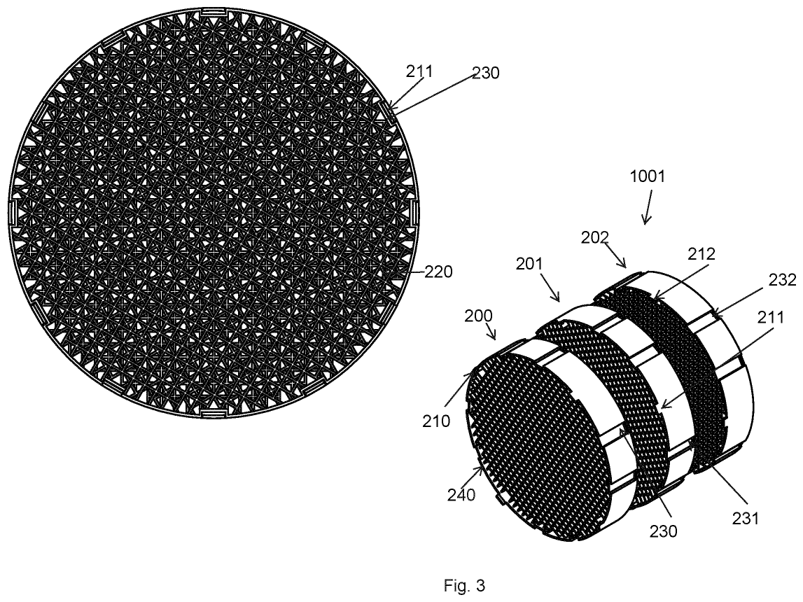

FIG. 3: a front view and an exploded diagram of a further embodiment of a modular heat exchanger having three heat exchanger units,

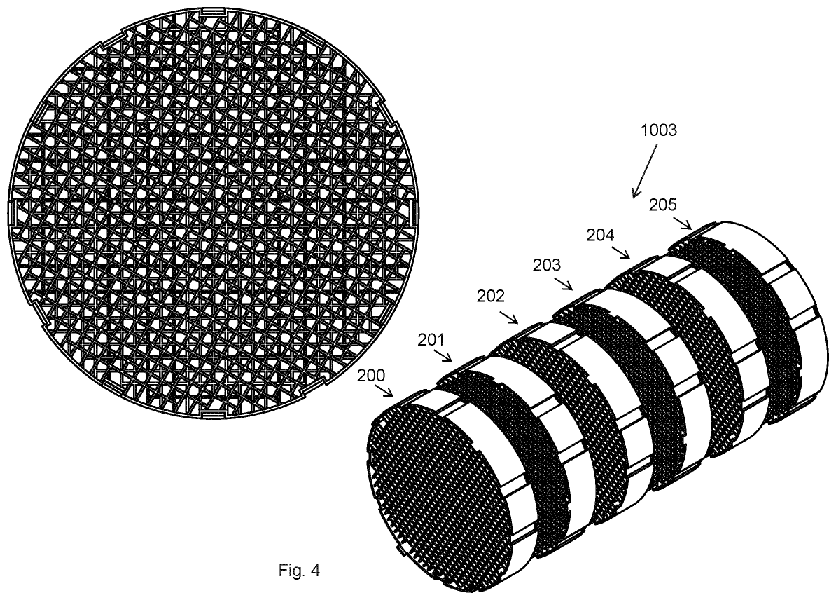

FIG. 4: a front view and an exploded diagram of a further embodiment of a modular heat exchanger having six heat exchanger units,

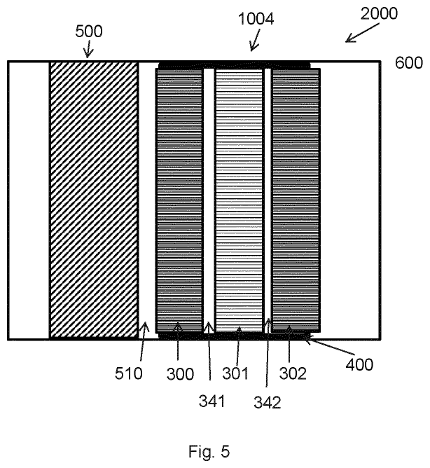

FIG. 5: a section view of one embodiment of a ventilation system in the second aspect of the invention,

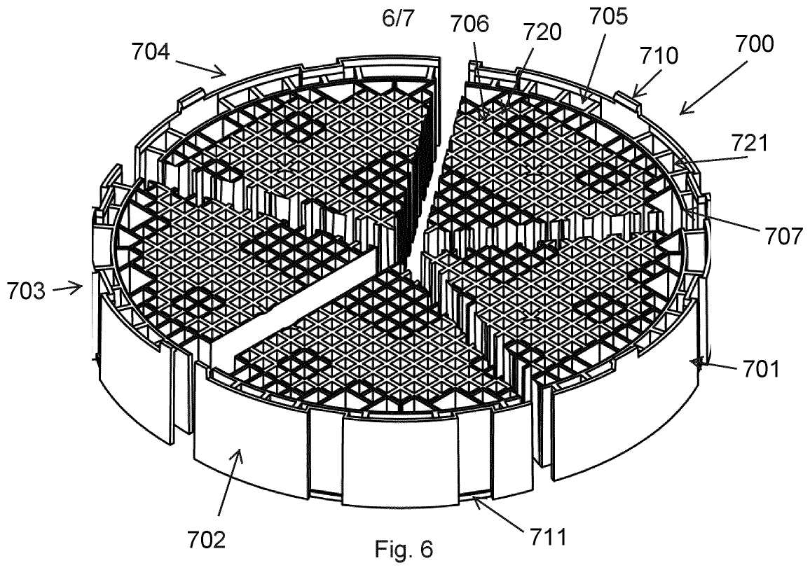

FIG. 6: a three-dimensional diagram of heat exchanger units of a further embodiment of a modular heat exchanger of the invention,

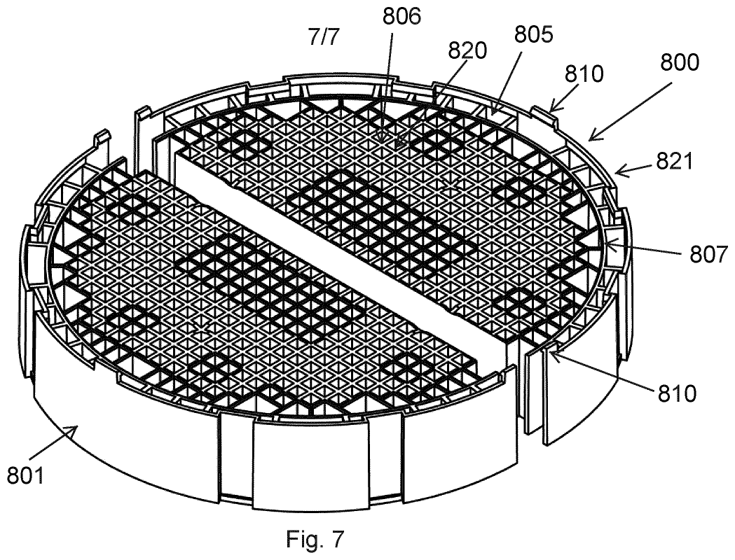

FIG. 7: a three-dimensional diagram of heat exchanger units of a further embodiment of a modular heat exchanger of the invention,

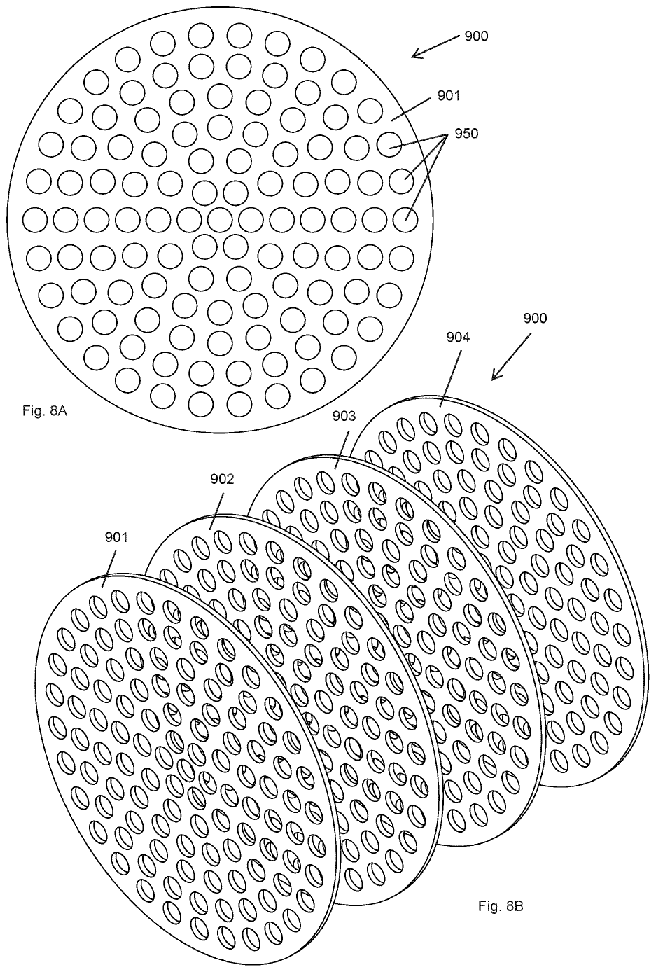

FIG. 8A: a front view of a further embodiment of a heat exchanger of the invention

FIG. 8B: a three-dimensional diagram of the embodiment of a heat exchanger of the invention from FIG. 8A

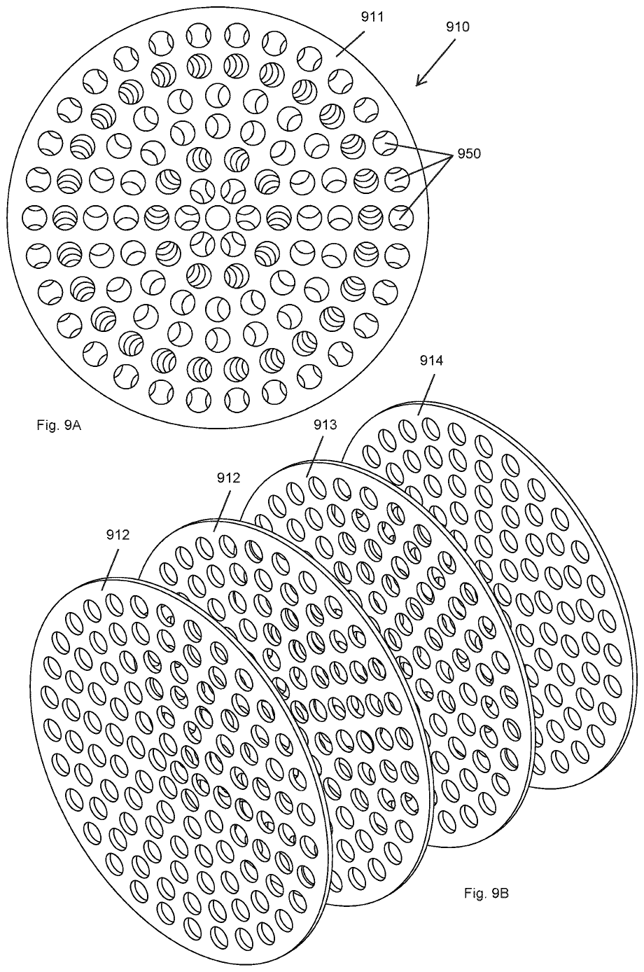

FIG. 9A: a front view of a further embodiment of a heat exchanger of the invention

FIG. 9B: a three-dimensional diagram of the embodiment of a heat exchanger of the invention from FIG. 9A

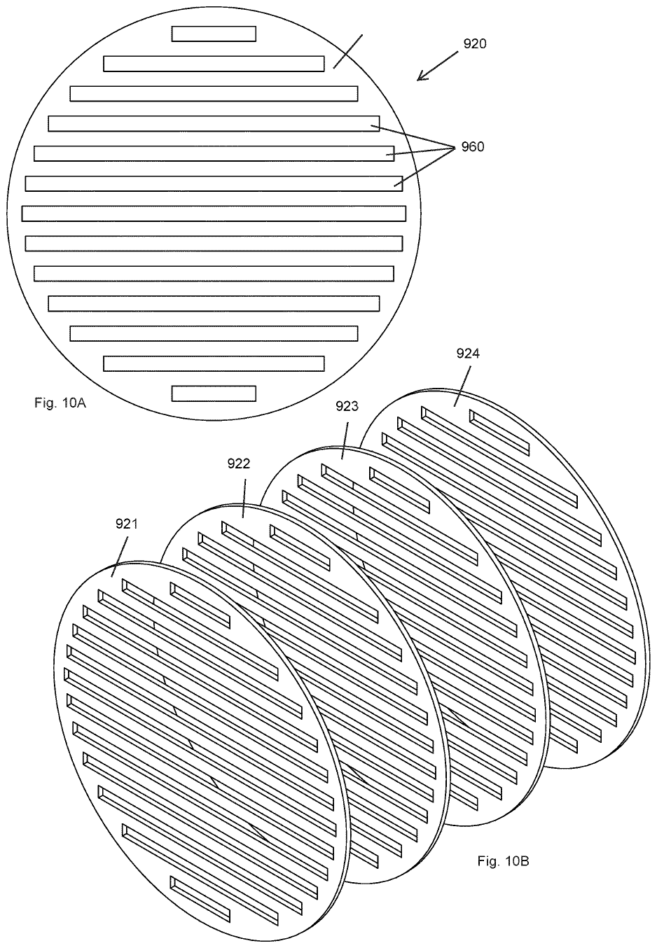

FIG. 10A: a front view of a further embodiment of a heat exchanger of the invention

FIG. 10B: a three-dimensional diagram of the embodiment of a heat exchanger of the invention from FIG. 10A

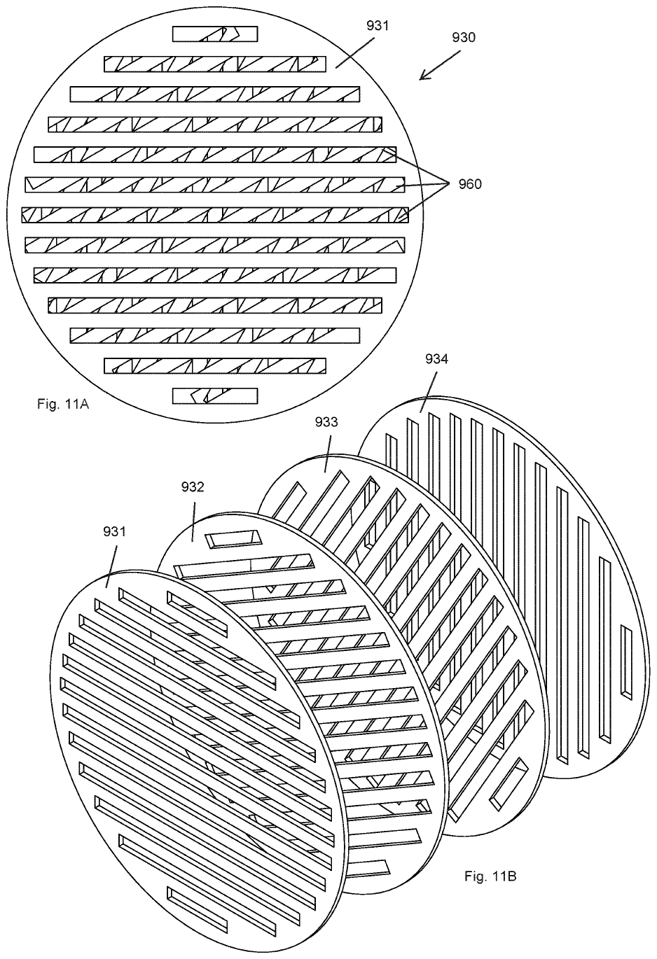

FIG. 11A: a front view of a further embodiment of a heat exchanger of the invention

FIG. 11B: a three-dimensional diagram of the embodiment of a heat exchanger of the invention from FIG. 11A

FIG. 12: various cross-sectional shapes for channels of a heat exchanger of the invention

In the description of working examples that follows, similar reference numerals generally relate to similar elements.

FIG. 1 shows a three-dimensional diagram of a heat exchanger unit 100 of one embodiment of a modular heat exchanger of the invention. The heat exchanger unit is in the form of a gas-solid heat exchanger having a multitude of flow channels 120. The heat exchanger unit 100 has an arrangement of four connecting elements 110. The connecting elements 110 in the embodiment shown take the form of springs that can engage in grooves, for example, in a heat exchanger unit 100 of the same construction. The heat exchanger unit 100 has a multitude of grooves 130; this makes it possible to rotate the heat exchanger units of the same construction relative to one another on assembly of the modular heat exchanger. This is elucidated in detail by FIGS. 2 to 4. In addition, the heat exchanger unit comprises a spacer 140, in the form here of a circumferential edge, which protrudes beyond the inflow plane of the flow channels and hence of the heat exchanger unit. The spacer 140, on which the connecting elements 110 are shaped in the form of springs, ensures that, in an assembled state of the modular heat exchanger, an inflow plane of the heat exchanger unit is spaced apart from an outflow plane of an adjacent heat exchanger unit; the distance here is 3-5 mm.

The flow channels 120 of the heat exchanger unit 100, in the embodiment shown, have rectangular cross sections, except for the outermost channels that conclude at a wall of the round heat exchanger unit. In embodiments that are not shown here, hexagonal, polygonal or round cross sections are also possible. The flow channels 120 shown here have a cross section which is uniform over the length of the heat exchanger unit and are also of the same construction over the cross section of the heat exchanger unit. In alternative variants that are not shown here, the cross sections of the flow channels may vary both over the length of the heat exchanger unit and over the cross section of the heat exchanger unit. Such embodiments promote efficient exploitation of available flow profiles of ventilators or further components when the modular heat exchanger is used in ventilation systems. The heat exchanger unit may have been manufactured from ceramic, but also from polymer materials, particularly because of the efficiency-increasing measures such as distance and deflection in the case of a twisted arrangement. Preference is given here particularly to polystyrene or ABS (acrylonitrile-butadiene-styrene copolymer).

FIG. 2 shows a front view and an exploded diagram of an embodiment of a modular heat exchanger 1000 with three heat exchanger units 200, 201, 202 of the same construction. The heat exchanger units 200, 201, 202 are of similar construction to the heat exchanger unit shown in FIG. 1. What follows hereinafter is a discussion primarily of the differences and supplementary aspects. Only the grooves 230, 231, 232 are formed here as grooves that extend over the entire length of the respective heat exchanger unit. In the assembled state, corresponding connecting elements in the form of springs 210, 211, 212 engage in these grooves. In the embodiment of the modular heat exchanger 1000 shown, the middle heat exchanger unit 201 is twisted by 30° compared to the heat exchanger units 200 and 202. The twisted arrangement is advantageous the it steers at least portions of an air stream conducted through the modular heat exchanger 1000 at the transition from one heat exchanger unit to the next, the completely straight flow through the heat exchanger is not possible. The deflection increases the probability that air molecules will come into contact with the channel walls in the channel of the next heat exchanger unit. In addition, there is an increase in heat transfer, and the efficiency of the heat exchanger is increased compared to heat exchangers without deflection. The deflection is readily apparent in front view in some of the through channels. For example, the through channel 221b of the middle heat exchanger 201 is arranged by virtue of the twisting such that it intersects with several channels 220 of the first heat exchanger 200, and there is a junction of lands of the first heat exchanger 200 virtually centrally in front of the through channel 221b. It is thus possible for only small proportions of the flow to pass directly into the through channel 221b. By contrast, virtually completely straight flow is possible through the through channel 221a. In this channel 221a, there is generally less heat transfer than in channel 221b. The through channels in the heat exchanger unit 202 cannot be seen since this heat exchanger unit 202 is aligned in the same way as the heat exchanger unit 200. FIGS. 3 and 4 that follow show further arrangements of heat exchanger units in modular heat exchangers with which efficiency can be increased further.

The deflection also promotes vortexing of the air flow in the interspaces between an outflow plane of the channels of one heat exchanger unit and an inflow plane of the next heat exchanger unit in flow direction that arise as a result of the spacers 240. This too contributes to an increase in contacts of the air molecules with the channel walls in the downstream heat exchanger unit, and hence to an increase in efficiency.

In front view, it can likewise be seen how the springs 211 engage in grooves 230 and hence connect the heat exchanger units to one another.

FIG. 3 shows a front view and an exploded diagram of a further embodiment of a modular heat exchanger 1001 with three heat exchanger units 200, 201, 202. The heat exchanger units 200, 201, 202 correspond to the construction shown in FIG. 2. By comparison with FIG. 2, the only change is in the arrangement of the heat exchanger units relative to one another. Heat exchanger unit 200 here is also in a twisted arrangement compared to heat exchanger unit 202. In the embodiment shown, all heat exchanger units are thus in a twisted arrangement relative to one another, here each by 30° relative to the adjacent heat exchanger unit. With the resulting further decrease in pathways along which straight flow is possible through the entire heat exchanger, the efficiency of the modular heat exchanger 1001 is further improved.

FIG. 4 likewise shows a front view and an exploded diagram of a further embodiment of a modular heat exchanger 1001 with six heat exchanger units 200, 201, 202, 203, 204, 205. The heat exchanger units 200, 201, 202, 203, 204, 205 likewise correspond to the construction shown in FIG. 2. A further way of increasing efficiency by means of variation of the modular construction is shown here; firstly, the heat exchanger 1002 is longer overall, i.e. there are also more available options for heat transfer over the length; secondly, every second heat exchanger unit is twisted here by 60° relative to the adjacent heat exchanger unit, resulting in a deflection and hence an increase in efficiency for high proportions of the flow from each heat exchanger unit to the next heat exchanger unit.

FIG. 5 shows a section view of one embodiment of a ventilation system 2000 in the second aspect of the invention. The ventilation unit 2000 has a ventilator 500 which is bidirectionally operable here and a modular heat exchanger 1004 having three heat exchanger units 300, 301, 302. These are arranged in a common housing 600 in the embodiment shown. The common housing in the simplest case may be a ventilation tube, but may also comprise, for example, a thermal insulation. The bidirectionally operable ventilator 500 is spaced apart from the modular heat exchanger 1004. There is therefore an interspace 510 between ventilator 500 and modular heat exchanger 1004. In this interspace 510, there may be a flow homogenizer made of porous material, at the deflectors of which air molecules are deflected such that dead zones that arise behind the ventilator are compensated for and there is uniform flow toward the modular heat exchanger 1004 over its entire cross section. In alternative embodiments, it is also possible to use a first heat exchanger unit adjacent to the ventilator 500 which is solid in regions where there is in any case zero or no flow because of a dead zone, such that any air flows are deflected into other channels.

The three heat exchanger units 300, 301, 302 are of different construction in the embodiment shown. In particular, the middle heat exchanger unit 301 here has through channels having a hexagonal cross section and smaller wall thicknesses than those of the channels of the heat exchanger units 300 and 302. The heat exchanger units 300 and 302 have through channels having square cross sections and are twisted relative to one another by 60°. The inflow plane of each heat exchanger unit is spaced apart from the outflow plane of that through which the flow previously passed, here at a distance of 5 mm. In the interspaces 341, 342 between the heat exchanger units 300 and 301, and 301 and 302, may be disposed a porous material in each case, where the porous material is especially a wadding, a fleece, a foam material. It is particularly advantageous here when the porous material has a cell structure which is thin compared to passages in the material. Foam materials used are preferably foam materials having an amount of pores in the range of 10-30 ppi, further preferably of 10-20 ppi. The use of such porous material in the interspaces increases the efficiency of the modular heat exchanger and hence the ventilation system as well.

The heat exchanger units 300, 301, 302, in the embodiment shown, are disposed in a housing 400 that serves as connecting element and spacer. The housing 400 additionally also has thermal insulation and hence avoids unwanted heat losses to the outside.

FIG. 6 shows a three-dimensional diagram of multiple heat exchanger units 700, 701, 702, 703, 704 of one embodiment of a modular heat exchanger of the invention. The heat exchanger units 700, 701, 702, 703, 704 shown, in the embodiment shown, form a plane of the heat exchanger, and they are flowed through in parallel in operation. The heat exchanger units are in the form of gas-solid heat exchangers having a multitude of flow channels 720. There is one connecting element 710 disposed on the heat exchanger unit 700. The connecting element 710 in the embodiment shown takes the form of hooks that can engage, for example, in an appropriate cutout 711 of a heat exchanger unit of the same construction.

The flow channels 720 of the heat exchanger unit 700, in the embodiment shown, have rectangular cross sections, except for the outermost channels that conclude at a dividing wall 707 of the heat exchanger unit 700. The flow channels 720 shown here have a uniform cross section over the length of the heat exchanger unit. The dividing wall 707 here separates a region 706 of the heat exchanger unit wherein air flows through the flow channels 720 in operation from a region 705 through which cables, for example, can be conducted. In region 705, the channels 721 are executed with greater cross sections compared to region 706, in order to achieve easy passage of cables. The dividing wall 707 ensures here that air flows through the heat exchanger unit only in region 706 in operation.

The heat exchanger units 701, 702, 703, 704 are correspondingly each assembled in the form of a circle segment to form heat exchanger unit 700, and may be combined therewith to form a plane of a heat exchanger which, as a result, has a round outer cross section after assembly. Such a plane of the heat exchanger may then be assembled together with one or more heat exchanger units that form(s) a further plane to give the heat exchanger.

FIG. 7 shows a three-dimensional diagram of two heat exchanger units 800, 801 of one embodiment of a modular heat exchanger of the invention. As in FIG. 6, the heat exchanger units 800, 801 shown, in the embodiment shown, form a plane of the heat exchanger, and they are flowed through in parallel in operation. The heat exchanger units 800, 801 are formed here in the form of semicircle segments. The heat exchanger units here too are in the form of gas-solid heat exchangers having a multitude of flow channels 820. There is an arrangement of multiple connecting elements 810 in the form of hooks on the heat exchanger unit 800.

The flow channels 820 of the heat exchanger unit 800, in the embodiment shown, have rectangular cross sections, except for the outermost channels that conclude at a dividing wall 807 of the heat exchanger unit 800.

Here too, as in FIG. 6, the dividing wall 807 separates a region 806 of the heat exchanger unit wherein air flows through the flow channels 820 in operation from a region 805 through which cables, for example, can be conducted. In region 805, the channels 821 are executed with greater cross sections compared to the flow channels in region 806, in order to achieve easy passage of cables. The dividing wall 807 here too ensures that air flows through the heat exchanger unit only in region 806 in operation. In further embodiments that are not shown here, the dividing wall may also separate two regions from one another through which flow passes in different directions.

FIG. 8A shows a front view, FIG. 8B a three-dimensional diagram, of one embodiment of a modular heat exchanger 900 of the invention. The heat exchanger units 901, 902, 903, 904 are in the form of gas-solid heat exchangers having a multitude of flow channels 950. The channels 950 all have round cross sections here. The heat exchanger units 901, 902, 903, 904 are manufactured here from metallic sheets and may be bonded to one another by means of a connecting element (not shown here) in the form of a rod disposed in the middle. In the embodiment of FIGS. 8A and 8B, the heat exchanger units 901, 902, 903, 904 are in a flush arrangement relative to one another, such that, in front view, all channels 950 are completely uncovered, and the air flow can flow unhindered in each case. It is thus possible for a higher volume flow rate or a lower pressure buildup to be achieved than is the case for mutually twisted heat exchanger units and hence offset flow pathways.

FIGS. 9A and 9B show a heat exchanger 910, the heat exchanger units 911, 912, 913, 914 of which have the same construction as those of heat exchanger 900 from FIGS. 8A and 8B. Here, however, the heat exchanger units are each in a twisted arrangement relative to one another, such that the channels 950 each only partly overlap, and the air flow is deflected. This leads to higher efficiency of heat exchange, but with slight losses of volume flow or higher pressure than is the case with flush channels.

FIGS. 10A and 10B show a heat exchanger 920 with four heat exchanger units 921, 922, 923, 924, each of which have a multitude of rectangular flow channels 960. In the embodiment shown, the channels are in a flush arrangement to one another. A connecting element (not shown here) may, for example, be a housing having acceptors for the heat exchanger units. The heat exchanger units may be inserted into these acceptors and hence be in a mutually spaced-apart arrangement.

FIGS. 11A and 11B show a heat exchanger 930, the heat exchanger units 931, 932, 933, 934 of which have the same construction as those of heat exchanger 920 from FIGS. 10A and 10B. Here, however, the heat exchanger units are each in a twisted arrangement relative to one another, such that the channels 960 each only partly overlap, and the air flow is deflected. This leads to higher efficiency of heat exchange, but with slight losses of volume flow or higher pressure than is the case with flush channels.

FIG. 12 shows, by way of example, a multitude of possible cross sections for the flow channels of a heat exchanger of the invention.

### REFERENCE NUMERALS

100 heat exchanger unit
110 connecting element
120 channel
130 groove
140 spacer
200 heat exchanger unit
201 heat exchanger unit
202 heat exchanger unit
203 heat exchanger unit
204 heat exchanger unit
205 heat exchanger unit
210 spring
211 spring
212 spring
220 channel
230 groove
231 groove
232 groove
1000 heat exchanger
221a channel
221b channel
240 spacer
300 heat exchanger unit
301 heat exchanger unit
302 heat exchanger unit
341 interspace
342 interspace
400 housing
500 ventilator
510 interspace
600 common housing
700 heat exchanger unit
701 heat exchanger unit
702 heat exchanger unit
703 heat exchanger unit
704 heat exchanger unit
705 region
706 region
707 dividing wall
710 connecting element
711 cutout
720 channel
721 channel
800 heat exchanger unit
801 heat exchanger unit
805 region
806 region
807 dividing wall
810 connecting element
820 channel
821 channel
900 heat exchanger
901 heat exchanger unit
902 heat exchanger unit
903 heat exchanger unit
904 heat exchanger unit
910 heat exchanger
911 heat exchanger unit
912 heat exchanger unit
913 heat exchanger unit
914 heat exchanger unit
920 heat exchanger
921 heat exchanger unit
922 heat exchanger unit
923 heat exchanger unit
924 heat exchanger unit
930 heat exchanger
931 heat exchanger unit
932 heat exchanger unit
933 heat exchanger unit
934 heat exchanger unit
950 channels
960 channels
1001 heat exchanger
1002 heat exchanger
1004 heat exchanger
2000 ventilation system

1. A modular heat exchanger comprising
at least two heat exchanger units in the form of gas-solid heat exchangers, each having a multitude of flow channels, and
at least one connecting element by which the heat exchanger units are connectable to one another.

2. The modular heat exchanger as claimed in claim 1, in which the at least two heat exchanger units are in plate form, with a polygonal or round cross section, or in the form of circle segments.

3. The modular heat exchanger as claimed in claim 1, in which at least two heat exchanger units are in an arrangement that enables parallel flow.

4. The modular heat exchanger as claimed in claim 1, in which at least one heat exchanger unit is connected in series with at least one further heat exchanger unit in an assembled state.

5. The modular heat exchanger as claimed in claim 1, in which at least one of the flow channels in at least one of the heat exchanger units has a rectangular, hexagonal, polygonal or round cross section and/or at least one of the flow channels has a cross section which is variable over the length of the heat exchanger unit and/or at least one of the channels is in straight or sinuous form.

6. The modular heat exchanger as claimed in claim 1, in which there is an arrangement of channels having different cross sections in at least one of the heat exchanger units, especially with cross sections that differ with regard to a basic shape and/or size.

7. The modular heat exchanger as claimed in claim 1, in which at least one heat exchanger unit has a channel structure that varies in a regular manner over its cross section, especially channels having greater diameter in an inner region and channels having a smaller diameter in the outer region.

8. The modular heat exchanger as claimed in claim 1, further comprising at least one blockade body which is in the form of circle segments and does not have any flow channels and which is connectable via the at least one connecting element to at least one of the heat exchanger units.

9. The modular heat exchanger as claimed in claim 1, in which at least one of the heat exchanger units comprises a ceramic, a polymer material, especially polystyrene or ABS, or a metallic material, especially a stainless steel.

10. The modular heat exchanger as claimed in claim 1, in which at least one of the channels of at least one of the heat exchanger units has an internal coating or internal structuring.

11. The modular heat exchanger as claimed in claim 1, in which the connecting element is formed on at least one of the heat exchanger units.

12. The modular heat exchanger as claimed in claim 1, in which the connecting element is a separate component, disposed between the heat exchanger units in an assembled state or an acceptor disposed around at least parts of the heat exchanger units or a housing around the heat exchanger units.

13. The modular heat exchanger as claimed in claim 1, having a dividing wall between the at least two heat exchanger units, by means of which two air streams are fully fluidically separable from one another, where the dividing wall is in particular a straight wall or a closed ring.

14. The modular heat exchanger as claimed in claim 1, comprising a spacer disposed between the at least two heat exchanger units in an assembled state, where the spacer is formed on at least one of the heat exchanger units or as a separate spacer or as part of the connecting element.

15. The modular heat exchanger as claimed in claim 14, in which the spacer is designed and/or arranged so as to fluidically separate a first set of channels of a heat exchanger unit from a second set of channels of that heat exchanger unit in the assembled state.

16. The modular heat exchanger as claimed in claim 1, in which there is a porous material disposed between the at least two heat exchanger units, where the porous material is especially a wadding, a fleece, a foam material.

17. The modular heat exchanger as claimed in claim 1, in which the at least two heat exchanger units are of different construction, and especially have different lengths, different channel structures and/or different materials.

18. The modular heat exchanger as claimed in claim 1, in which the at least two heat exchanger units are in a mutually twisted arrangement in an assembled state.

19. A ventilation system having at least one ventilator which is in particular bidirectionally operable and at least one modular heat exchanger as claimed in claim 1.

20. The ventilation system as claimed in claim 19, further comprising a flow homogenizer which is made of porous material and is disposed between the bidirectionally operable ventilator and the modular heat exchanger, and the deflectors of which deflect air molecules so as to compensate for dead zones that arise behind the ventilator.

21. A twin ventilation system for interior ventilation, having, in a common housing,
a first air guiding device for guiding a first air stream, having a first outlet on the interior side, a first flow space in which at least one first bidirectionally operable ventilator is disposed, and a first outlet on the outside,
a second air guiding device for guiding a second air stream, entirely fluidically separated from the first air guiding device and having a second outlet on the interior side, a second flow space in which at least one second bidirectionally operable ventilator is disposed, and a second outlet on the outside,
a modular heat exchanger as claimed in claim 1 which extends within the first and second air guiding devices, is disposed between the respective outlets on the interior side and the outside in both air guiding devices, and is designed to guide the first air stream and the second air stream in a fluidically separated but thermally coupled manner, where the modular heat exchanger additionally forms a regenerator in each case in the first and second air guiding devices,
wherein the first and second outlets on the interior side are in a fluidically completely separated arrangement in a common part-housing on the interior side, and the first and second outlets on the outside are in a fluidically completely separated arrangement in a common part-housing on the outside, and
wherein the first and second flow spaces and the modular heat exchanger are disposed in a common middle portion of the housing.
